(19) United States
(12) Patent Application Publication
(10) Pub. No.: US 2015/0103059 A1
(43) Pub. Date: Apr. 16, 2015

(54) METHOD AND APPARATUS OF CONTROLLING BRIGHTNESS OF DISPLAY

(71) Applicant: Samsung Electronics Co., Ltd., Gyeonggi-do (KR)

(72) Inventors: Han-sub Jung, Gyeonggi-do (KR); Dong-wook Kang, Seoul (KR); Hye-jin Kim, Gyeonggi-do (KR)

(73) Assignee: Samsung Electronics Co., Ltd.

(21) Appl. No.: 14/515,048

(22) Filed: Oct. 15, 2014

(30) Foreign Application Priority Data
Oct. 15, 2013 (KR) 10-2013-0122957

(51) Int. Cl. G09G 5/10

(52) U.S. Cl. CPC G09G 5/10; G09G 2320/0653; G09G 2354/00
USPC 345/207

(57) ABSTRACT

A method and apparatus for controlling a display is provided. The method includes detecting whether a change amount in brightness of an ambient environment of an apparatus, for a predetermined period of time, is greater than or equal to a reference value, determining brightness of the display, based on a result of the detecting, and when an operation signal of the display is detected, turning on the display according to the brightness determined at a time when the operation signal is detected.

### RELATED APPLICATIONS

This application claims priority under 35 U.S.C. § 119(a) to Korean Patent Application Ser. No. 10-2013-0122957, filed on Oct. 15, 2013, in the Korean Intellectual Property Office, the entire disclosure of which is incorporated herein by reference.

### BACKGROUND OF THE INVENTION

1. Field of Invention

One or more exemplary embodiments relates generally to a method and an apparatus of controlling brightness of a display, according to brightness of an ambient environment.

2. Description of the Related Art

When a display is located in a dark place, a human easily recognizes the display because the display is bright enough to be recognized by the human's eyes; however, even when the display has the same brightness, when the display is located in a place in which the sun shines brightly, the human does not easily recognize the display because the display is not bright enough to be recognized by the human's eyes.

Accordingly, the brightness of the display may be automatically changed based on the brightness of an ambient environment. In other words, when the display is located in the dark place, the brightness of the display may be automatically controlled to decrease, and when the display is located in the bright place, the brightness of the display may be automatically controlled to increase.

However, when the brightness of the ambient environment is changed from high to low, the user may be sensitive to the brightness of the display, according to a user's brightness adaptation state.

### SUMMARY

The exemplary embodiment has been made to address at least the problems and disadvantages described above, and to provide at least the advantages described below.

Accordingly, an aspect of the exemplary embodiment is to provide a method and an apparatus for controlling brightness of a display according to brightness of an ambient environment and a user's brightness adaptation state.

In accordance with an aspect of the exemplary embodiment, a method of controlling a display is provided. The method includes detecting whether a change amount in brightness of an ambient environment of an apparatus, for a predetermined period of time, is greater than or equal to a reference value, determining brightness of the display, based on a result of the detecting, and when an operation signal of the display is detected, turning on the display according to the brightness determined at a time when the operation signal is detected.

The determining of the brightness may include switching a mode of the apparatus to a light adaptation mode based on the result of the detecting; and when the mode is switched to the light adaptation mode, determining the brightness of the display of the apparatus based on at least one of a time when the mode is switched to the light adaptation and the change amount in the brightness of the ambient environment.

The detecting may include: standing by, when the approach of an object to the apparatus is detected, until the object that approaches the apparatus is no longer detected; and when the object that approaches the apparatus is no longer detected, detecting whether the change amount in the brightness of the ambient environment for the predetermined period of time is greater than or equal to the reference value.

When the mode is not switched to the light adaptation mode based on the result of the detecting, the determining of the brightness may include determining the brightness of the display of the apparatus based on a level of the brightness of the ambient environment of the apparatus.

The turning on of the display may include maintaining the brightness of the display at the time when the display was turned on until the display is turned off.

The reference value may be determined based on an amount of a brightness to which a user's eyes are adapted when dark adaptation or light adaptation progresses for the predetermined period of time.

In accordance with another aspect of the exemplary embodiment, an apparatus is provided. The apparatus includes a sensor unit for detecting whether a change amount in brightness of an ambient environment of an apparatus, for a predetermined period of time, is greater than or equal to a reference value, a control unit for determining brightness of the display, based on a result of the detecting, and when an operation signal of the display is detected, controlling the display to be turned on according to the brightness determined at a time when the operation signal is detected; and a display operating according to the operation signal and the determined brightness.

In accordance with another aspect of the exemplary embodiment, a non-transitory computer-readable recording medium is provided, the recording medium having recorded thereon a program which, when executed by a computer, performs the steps of detecting whether a change amount in brightness of an ambient environment of an apparatus, for a predetermined period of time, is greater than or equal to a reference value, determining brightness of the display, based on a result of the detecting, and when an operation signal of the display is detected, turning on the display according to the brightness determined at a time when the operation signal is detected.

### BRIEF DESCRIPTION OF THE DRAWINGS

The above and other aspects, features, and advantages of the exemplary embodiment will become apparent and more readily appreciated from the following description of the embodiments, taken in conjunction with the accompanying drawings in which:

FIG. 1 is a block diagram showing an internal structure of an apparatus, according to an exemplary embodiment;

FIG. 2 is a flowchart showing a method of controlling a brightness of a display, according to an exemplary embodiment;

FIG. 3A is a graph illustrating a progress of dark adaptation based on a brightness of an ambient environment, according to an exemplary embodiment;

FIG. 3B is a graph illustrating a method of controlling a brightness of a display in a dark adaptation state, according to an exemplary embodiment;

FIG. 4A is a graph illustrating a progress of light adaptation based on a brightness of an ambient environment, according to an exemplary embodiment;

FIG. 4B is a graph illustrating a method of controlling a brightness of a display in a light adaptation state, according to the exemplary embodiment; and

FIG. 5 is a flowchart showing a method of controlling a brightness of a display, according to an exemplary embodiment.

### DETAILED DESCRIPTION OF EMBODIMENTS OF THE PRESENT INVENTION

Reference will now be made in detail to embodiments, examples of which are illustrated in the accompanying drawings, wherein like reference numerals refer to like elements throughout. In this regard, the present embodiments may have different forms and are not to be construed as being limited to the descriptions set forth herein.

All terms including descriptive or technical terms which are used herein should be construed as having meanings that are obvious to one of ordinary skill in the art and should not be construed as terms that are defined in a general dictionary.

Also, when a part “includes” or “comprises” an element, unless there is a particular description contrary thereto, the part may further include other elements, not excluding the other elements. In the following description, terms such as “unit” and “module” indicate a unit for processing at least one function or operation, wherein the unit and the block is embodied as hardware or software or embodied by combining hardware and software.

One or more exemplary embodiments will now be described more fully with reference to the accompanying drawings. However, one or more embodiments of the invention may be embodied in many different forms and are not to be construed as being limited to the embodiments set forth herein. Rather, these embodiments are provided so that the description of this invention will be thorough and complete, and will fully convey the scope of the invention to those skilled in the art. The exemplary embodiments will be defined by the appended claims

In the following description, functions or constructions that are not related to one or more embodiments of the invention are not described. Throughout the specification, like reference numerals denote like elements. Expressions such as “at least one of,” when preceding a list of elements, modify the entire list of elements and do not modify the individual elements of the list.

Hereinafter, one or more embodiments of the invention will be described with reference to the accompanying drawings.

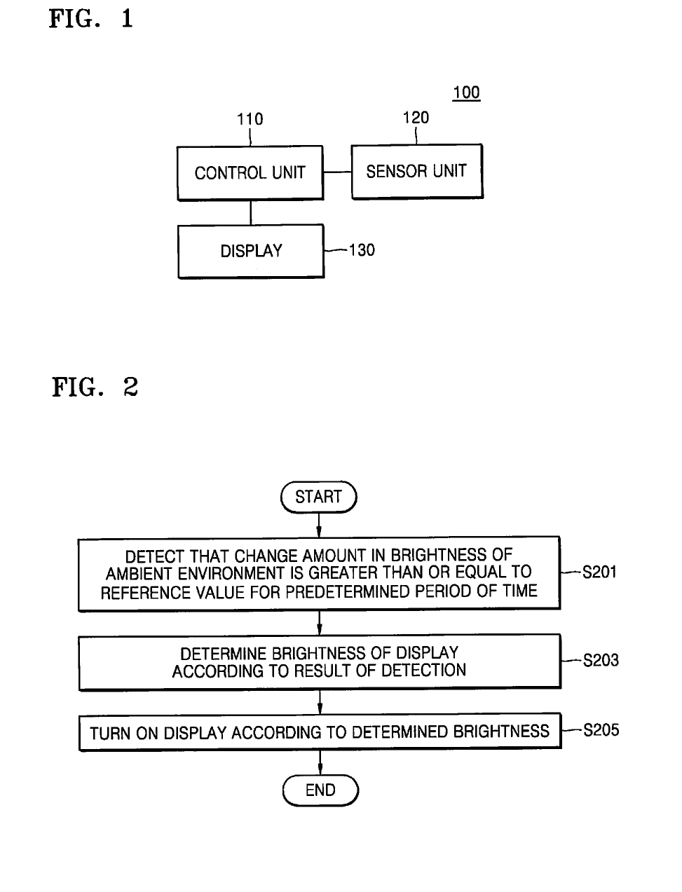

FIG. 1 is a block diagram showing an internal structure of an apparatus 100 according to an exemplary embodiment.

The apparatus 100 may include various types of apparatuses including a display that a user may use. For example, the apparatus 100 may include Personal Computers (PCs), laptop computers, mobile phones, tablet PCs, navigation terminals, smart phones, Personal Digital Assistants (PDAs), Portable Multimedia Players (PMPs), and digital broadcasting receivers. These are merely examples, and thus the apparatus 100 may include apparatuses that have already been developed and commercialized or that will be developed in the future, in addition to the above-mentioned examples.

Referring to FIG. 1, the apparatus 100 may include a control unit 110, a sensor unit 120, and a display 130. However, not all shown components are essential components. That is, the apparatus 100 may be embodied with more or less components than the components shown in FIG. 1.

Hereinafter, the components will be examined in order.

The control unit 110 may generally control all operations of the apparatus 100. For example, the control unit 110 may determine a brightness of the display 130 based on a change in a brightness of an ambient environment sensed by the sensor unit 120, and may control the display 130 to be displayed according to the determined brightness. In other words, the control unit 110 may generally control the sensor unit 120 and the display 130.

In the exemplary embodiment, before the display 130 is turned on, when a change amount in the brightness of the ambient environment around the apparatus 100 is greater than or equal to a reference value for a predetermined period of time, the control unit 110 may determine the brightness of the display 130. When the display 130 is turned on, the control unit 110 may control the display 130 to be turned on according to the brightness determined at a time when the display is turned on. In other words, when the change amount in the brightness of the ambient environment around the apparatus 100 is greater than or equal to the reference value over the predetermined period of time, the control unit 110 may determine that a user's eyes undergo dark adaptation or light adaptation according to the change in the brightness, and may determine the brightness of the display 130 in consideration of the determination.

Here, the reference value with respect to the change amount in the brightness of the ambient environment around the apparatus 100 may be determined based on an amount of a brightness to which human's eyes may be adapted as dark adaptation or light adaptation is performed for a predetermined period of time.

In more detail, the control unit 110 may switch a mode of the apparatus 100 to a light adaptation mode according to the change amount in the brightness of the ambient environment, and may determine the brightness of the display 130 based on at least one of a time when the mode is switched to the light adaptation mode and the change amount in the brightness. In other words, the control unit 110 may determine the brightness of the display 130 based on the change amount in the brightness and the time that elapsed after switching to the light adaptation mode which are used by the user to determine whether it is the dark adaptation state or the light adaptation state.

The dark adaptation refers to a phenomenon in which, when a person moves from a bright place to a dark place, the person has a difficulty in seeing surrounding objects at first, but in time as their eyes adapt to the darker environment, the person is able to see the surrounding objects.

The retina of the human eye is composed of two main photoreceptor cells—rod cells and cone cells. Rod cells, or rods, require less light to function than cone cells, or cones. Since the human's eyes may respond to a very small amount of light because a threshold value of a rod is very small, sensitivity of the rod, rather than that of the cone, increases while the dark adaptation proceeds and therefore a threshold value of vision may be changed. Therefore, when the dark adaptation proceeds, the person may see the surrounding objects in the dark place because the threshold value of vision decreases and thus the person may well recognize the surrounding objects with a small amount of light.

Rhodopsin is a pigment which is present in the photoreceptor cells of the retina and is responsible for the first events in the perception of light. As rhodopsin in the rod is synthesized, the sensitivity of the rod may increase. In order words, when the synthesized rhodopsin is gathered in the rod, the sensitivity of the rod may increase. When the synthesis of rhodopsin is completed and therefore the sensitivity of the rod is maximized, the dark adaptation may be completed. The dark adaptation may be completed after the brightness starts to change and then approximately 45 minutes elapses, based on when the brightness is changed in several seconds from 5000 Lux that is a general brightness level in the outdoor in which the sun shines to 0 Lux that is a brightness level without any light. Therefore, while the human's eyes undergo the dark adaptation, rhodopsin of the rod is synthesized and therefore the threshold value of vision in the dark place gradually decreases. Therefore, the person is able to see the surrounding objects with the small amount of light.

In addition, the light adaptation is opposite to the dark adaptation, and refers to a phenomenon in which, when a person moves from a dark place to a bright place, the human's eyes do not adapt to the bright light, and thus the person has a difficulty in seeing well enough to recognize surrounding objects at first, but in time, the human's eyes adapt. When the person who has been in the dark adaptation in the dark place moves to the bright place, the rhodopsin of the rod decomposes and the sensitivity of the cone increases. Therefore, the light adaptation may proceed. The cone has a threshold value of light higher than that of the rod. Thus, when the sensitivity of the cone increases, the person may see the objects well in the bright light. The light adaptation in which the rhodopsin of the rod may be decomposed may proceed faster than the synthesis of rhodopsin in the rod, and thus the light adaptation may be completed in about 1 minute, based on when the luminance changes from 0 Lux to 5000 Lux in several seconds.

The control unit 110 may estimate a time that elapses until the dark adaptation, with respect to the user's eyes, is completed, and when the display 130 is turned on before the time with respect to the completion of the dark adaptation elapses, the control unit 110 may control the brightness of the display 130 according to the state of the dark adaptation. When the display 130 is turned on before the dark adaptation is completed, the user's eyes are adapted to the light brighter than the brightness of the ambient environment, because the user's eyes still undergo the dark adaptation based on the brightness of the ambient environment. Therefore, the control unit 110 may control the display 130 to be displayed in a state brighter than the brightness of the display 130 which may be determined according to the brightness of the ambient environment. In other words, before the dark adaptation is completed, the threshold value of vision of the user's eyes is not yet low enough, compared to the brightness of the ambient environment.

Therefore, the display 130 may be controlled to be displayed in the state relatively brighter than the brightness of the display 130 which may be determined according to the brightness of the ambient environment. Here, the brightness of the display 130 which may be determined according to the brightness of the ambient environment may be determined as a brightness of the display 130 which may be recognized as an optimum brightness based on when the dark adaptation with respect to the user's eyes is completed.

In addition, the control unit 110 may estimate a time that elapses until the light adaptation with respect to the user's eyes is completed, and when the display 130 is turned on before the time with respect to the completion of the light adaptation elapses, the control unit 110 may control the brightness of the display 130 according to the state of the light adaptation. When the display 130 is turned on before the light adaptation is completed, the user's eyes are adapted to the light darker than the brightness of the ambient environment, because the user's eyes still undergo the light adaptation based on the brightness of the ambient environment. Therefore, the control unit 110 may control the display 130 to be displayed in a state darker than the brightness of the display 130, which may be determined according to the brightness of the ambient environment. In other words, before the light adaptation is completed, the threshold value of vision of the user's eyes is not yet high enough, compared to the brightness of the ambient environment. Therefore, the display 130 may be controlled to be displayed in the state relatively darker than the brightness of the display 130, which may be determined according to the brightness of the ambient environment.

Since the user may see the display 130 with a brightness that is darkened according to the progress of the user's light adaptation, when the display 130 is turned on, the user may see the display 130 optimally without being blinded because an amount of light greater than that of a current threshold value of vision is generated. Here, the brightness of the display 130 which may be determined according to the brightness of the ambient environment may be determined as a brightness of the display 130, which may be recognized as an optimum brightness based on when the light adaptation with respect to the user's eyes is completed.

Furthermore, because the light adaptation may be quickly completed in about 1 minute, the control unit 110 may control the brightness of the display 130 according to the brightness of the ambient environment, without considering whether the light adaptation is completed. Because a time in which the brightness of the display 130 may be controlled according to the progress state of the light adaptation is as brief as a time period in which the light adaptation begins and then is completed, controlling the brightness of the display 130 according to the progress of the light adaptation will not significantly affect the user. In other words, because the light adaptation may be quickly completed, when the control of the brightness of the display 130 according to the brightness of the ambient environment and the control of the brightness of the display 130 according to the progress of the light adaptation are compared, the user will not sense the significant difference. Therefore, although the change in the brightness of the ambient environment is sensed, when the brightness of the ambient environment is changed to be brighter, the control unit 110 may control the brightness of the display 130 according to the brightness of the ambient environment at a time of controlling the brightness of the display 130, without considering whether the light adaptation proceeds.

The sensor unit 120 may sense current states of the apparatus 100, such as the brightness of the ambient environment of the apparatus 100 or a contact between the apparatus 100 and the surrounding objects, and may generate a sensing signal of controlling the brightness of the display 130 of the apparatus 100.

The sensor unit 120 may include a brightness sensor capable of sensing the brightness of the ambient environment and a proximity sensor capable of sensing a contact between the apparatus 100 and the surrounding objects.

The brightness sensor may measure a brightness intensity of an ambient environment of the apparatus 100. Therefore, the control unit 110 may use the brightness intensity of the ambient environment measured by the brightness sensor so as to control the brightness of the display 130 according to the progress of the light adaptation or the dark adaptation.

The proximity sensor senses existence of an object that approaches a detection surface or that exists nearby, by using a force of an electro-magnetic field or an infrared ray, without using a mechanical contact.

Examples of the proximity sensor include a transmission-type photoelectric sensor, a direction reflection-type photoelectric sensor, a mirror reflection-type photoelectric sensor, a high frequency oscillation-type proximity sensor, a capacity-type proximity sensor, a magnetic proximity sensor, an infrared-type proximity sensor, or the like.

In the present embodiment, the proximity sensor may sense the object that approaches the apparatus 100. Therefore, according to a result of the sensing by the proximity sensor, the apparatus 100 may determine whether the brightness that is measured by the brightness sensor is measured with respect to the ambient environment, or whether the brightness is measured in a state in which light entering the brightness sensor is blocked by an approaching object. When the brightness measured by the brightness sensor is changed because the object approaches the apparatus 100 or the user puts the apparatus 100 into his/her pocket, the apparatus 100 may determine that the brightness of the ambient environment is not changed, and therefore may stand by without determining the brightness of the display 130 according to the measured brightness. The apparatus 100 may not determine the brightness of the display 130 according to the measured brightness even when the brightness measured by the brightness sensor is changed, and may stand by until the object that was sensed by the proximity sensor is no longer sensed. When the approaching object is not sensed by the proximity sensor, the apparatus 100 may measure the brightness of the ambient environment and therefore may determine the brightness of the display 130.

The display 130 may display information that is processed in the apparatus 100. Here, the display 130 may display the information based on the brightness determined by the control unit 110.

The display 130 may include, but is not limited thereto, at least one of a Liquid Crystal Display (LCD), a Thin Film Transistor-Liquid Crystal Display (TFT-LCD), an organic light-emitting display device, a flexible display, and a three-dimensional (3D) display. In addition, the apparatus 100 may include at least two displays 130 in another embodiment.

In the present embodiment, determination of the brightness of the display 130 according to the change in the brightness of the ambient environment may be performed by an external device, other than the control unit 110 of the apparatus 100. In other words, the apparatus 100 may transmit brightness information measured by the sensor unit 120 to the external device, and may receive brightness information of the display 130 which is determined according to the transmitted brightness information. The apparatus 100 may control the brightness of the display 130 according to the received brightness information. Therefore, the apparatus 100 may not require components for performing an operation of determining the brightness of the display 130 according to the change in the brightness of the ambient environment. Here, the control unit 110 of the apparatus 100 may perform only a basic operation of controlling internal components of the apparatus 100 and may not perform the operation of determining the brightness of the display 130, according to the exemplary embodiment described herein.

FIG. 2 is a flowchart showing a method of controlling a brightness of the display 130, according to an exemplary embodiment.

Referring to FIG. 2, in step S201, the apparatus 100 may detect that a change amount in brightness of an ambient environment of the apparatus 100 is greater than or equal to a reference value for a predetermined period of time. In order words, the apparatus 100 may determine whether a user is in a dark adaptation state or a light adaptation state, based on the change amount in the brightness of the ambient environment.

The apparatus 100 may detect that the change amount in the brightness of the ambient environment is greater than or equal to the reference value for the predetermined period of time while the display 130 is turned off, and may determine the brightness of the display 130 according to a result of the detection. In other words, the apparatus 100 may periodically determine the brightness of the display 130 while the display is turned off, and when the display is turned on, the apparatus 100 may control the brightness of the display 130 according to the brightness that is periodically determined while the display is turned off.

When a brightness of an ambient environment is significantly changed for a short time, sensitivity of a cone or a rod may be changed enough for a human's eyes to see surrounding objects in the brightness of the ambient environment according to the change in the brightness of the ambient environment. However, because the sensitivity of the cone or the rod may be changed slower than a level of the change in the brightness of the ambient environment, immediately after the brightness of the ambient environment is changed, the human's eyes may undergo the dark adaptation or the light adaptation. A time that elapses to complete the dark adaptation or the light adaptation may be proportional to the change amount in the brightness of the ambient environment. Also, as long as the change in the brightness continues, the dark adaptation or the light adaptation may continually progress.

However, when the change in the brightness is performed slower than a level of the progress with respect to the dark adaptation or the light adaptation, the dark adaptation or the light adaptation may be immediately completed every time the brightness of the dark adaptation or the light adaptation is changed. In other words, when the change amount in the brightness of the ambient environment for a predetermined period of time is equal to or less than the reference value, the apparatus 100 may determine that the dark adaptation or the light adaptation with respect to the user's eyes is completed, according to the change in the brightness. Therefore, the apparatus 100 may determine the brightness of the display 130 according to the measured brightness of the ambient environment, without consideration of a progress state with respect to the dark adaptation or the light adaptation.

On the other hand, when the change amount in the brightness of the ambient environment for the predetermined period of time is greater than or equal to the reference value, the apparatus 100 may determine that the user's eyes undergo the dark adaptation or the light adaptation according to the change in the brightness, so that the apparatus 100 may determine the brightness of the display 130 in consideration of the progress state with respect to the dark adaptation or the light adaptation.

In step S203, the apparatus 100 may determine the brightness of the display 130 of the apparatus 100 based on the result of the detection performed in step S201. As described above, the apparatus 100 may determine the brightness of the display 130 according to the change in the brightness of the ambient environment while the display 130 is turned off In other words, the apparatus 100 may estimate the progress state with respect to the dark adaptation or the light adaptation according to the change in brightness of the ambient environment, and therefore may determine the brightness of the display 130. When the display 130 is turned on, the apparatus 100 may control the brightness of the display 130 according to the brightness that is determined based on a time when the display 130 is turned on. When the apparatus 100 determines that the user's eyes undergo the dark adaptation or the light adaptation based on the result detected in step S201, the apparatus 100 may determine the brightness of the display 130 according to the progress with respect to the dark adaptation or the light adaptation.

In more detail, the apparatus 100 may determine the brightness of the display 130 in consideration of a current level of the user's eyes with respect to the dark adaptation or the light adaptation. For example, when the apparatus 100 determines that the user's eyes undergo the dark adaptation, the apparatus 100 may determine that the user's eyes may optimally see the display 130 with the brightness that is slightly brighter than the brightness of the ambient environment. Therefore, the apparatus 100 may determine the brightness of the display 130 to be slightly brighter than a brightness of the display 130 which may be determined according to the brightness of the ambient environment. In this case, the target brightness of the display 130 may be determined based on a brightness value of the display 130 according to a preset progress time with respect to the dark adaptation. Afterward, when the dark adaptation is completed, the apparatus 100 may determine the brightness of the display 130 according to the brightness of the ambient environment, without considering whether the dark adaptation progresses.

In addition, when the apparatus 100 determines that the user's eyes undergo the light adaptation, the apparatus 100 may determine that the user's eyes may optimally see the display 130 with the brightness that is slightly darker than a brightness of the ambient environment. Therefore, the apparatus 100 may determine the brightness of the display 130 to be slightly darker than a brightness of the display 130 which may be determined according to the brightness of the ambient environment. In this case, the target brightness of the display 130 may be determined based on a brightness value of the display 130 according to a preset progress time with respect to the light adaptation. Afterward, when the light adaptation is completed, the apparatus 100 may determine the brightness of the display 130 according to the brightness of the ambient environment, without considering whether the light adaptation progresses.

Furthermore, as described above, when the apparatus 100 determines that the user's eyes undergo the light adaptation because the brightness of the ambient environment increases, the apparatus 100 may determine the brightness of the display 130 according to the brightness of the ambient environment, without considering whether the light adaptation progresses. Therefore, the apparatus 100 may not perform continuous monitoring and operation to determine the light adaptation state, but may determine the brightness of the display 130 according to the brightness of the ambient environment which was measured by the brightness sensor when the display 130 is turned on

On the other hand, when the apparatus 100 determines that the user's eyes do not undergo the dark adaptation or the light adaptation based on the result detected in step S201, the apparatus 100 may determine the brightness of the display 130 according to the brightness of the ambient environment measured by the brightness sensor. In this case, the apparatus 100 may determine the brightness of the display 130, according to the brightness of the ambient environment when the display 130 is turned on.

In step S205, according to the brightness of the display 130 determined in step S203, the apparatus 100 may control the brightness of the display 130, when the display 130 is turned on. Steps S201 through S203 may be periodically performed. Therefore, the apparatus 100 may control the display 130 to be displayed with the brightness that is determined in step 5203 at a time when the display 130 is turned on. In other words, the apparatus 100 may determine the brightness of the display 130 while the display 130 is turned off, and when the display 130 is turned on, the apparatus 100 may control the brightness of the display 130 according to the brightness that is determined based on the time when the display 130 is turned on.

Also, when the display 130 is turned on according to the brightness controlled in step S205, the apparatus 100 may control the display 130 to maintain the brightness that is determined in step S203, until the display 130 is turned off. In other words, the apparatus 100 may not control the display 130 to decrease or increase the brightness on the assumption that the dark adaptation or the light adaptation continually progresses, but may control the display 130 to maintain the brightness at the time when the display 130 is turned on. This is considered that, because the user's eyes face the display 130 when the display 130 is turned on, the user's eyes may continue to be adapted to the brightness of the display 130 rather than the brightness of the ambient environment.

In other words, because the user's eyes that have been undergoing the dark adaptation or the light adaptation according to the brightness of the ambient environment are adapted to the brightness of the display 130 when the display 130 is turned on, the dark adaptation or the light adaptation may discontinue. Here, the brightness of the turned-on display 130 corresponds to a brightness with which the user's eyes may optimally see, so that the dark adaptation or the light adaptation does not progress, and the brightness of the display 130 at the time when the display 130 is turned on may be maintained until the display 130 is turned off.

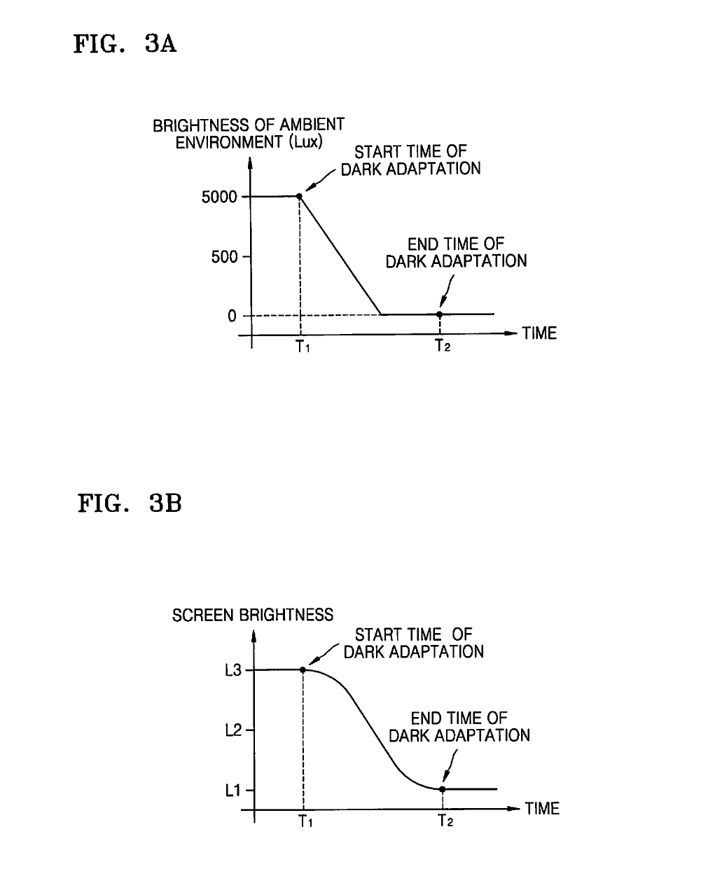

FIG. 3A is a graph illustrating a progress of dark adaptation based on a brightness of an ambient environment, according to an exemplary embodiment.

Referring to FIG. 3A, the brightness of the ambient environment may be changed from 5000 Lux, which is similar to a brightness value outdoors where the sun shines, to 0 Lux, which is similar to a brightness value in a place such as a dark room without any light during a period of time from a time T₁ to a time T₂. Here, a temporal difference between the time T₁ and the time T₂ may be shorter than a time until the dark adaptation is completed.

FIG. 3B is a graph illustrating a method of controlling a brightness of a display in a dark adaptation state, according to an exemplary embodiment.

Referring to FIG. 3B, according to a progress of dark adaptation, the apparatus 100 control the brightness of the display. A screen brightness L1 to L3, shown in FIG. 3B, corresponds to the brightness of the ambient environment 0 Lux to 5000 Lux, shown in FIG. 3A. In other words, when the brightness of the ambient environment is in a range between 0 Lux to 5000 Lux and the dark adaptation state or a light adaptation state is not considered, the apparatus 100 may control the brightness of the display to be the screen brightness L1 to L3.

While the display is turned off, the apparatus 100 may determine the brightness of the display according to the graph shown in FIG. 3B. When the display is turned on, the apparatus 100 may control the brightness of the display according to the brightness at a time when the display is turned on.

When the display is turned on, a user's eyes may be adapted to the brightness of the display as the user watches the display, so that the user's eyes may not undergo the dark adaptation or the light adaptation. Therefore, the apparatus 100 may not change the brightness of the display according to a progress of the dark adaptation or the light adaptation with respect to the user's eyes, which is estimated based on the change in the brightness of the ambient environment. A target brightness of the display, which is to be determined after the display is turned on, may be maintained at the brightness determined at the time when the display is turned on.

When the apparatus 100 determines that the dark adaptation progresses, the apparatus 100 may determine the brightness of the display based on the graph shown in FIG. 3B. The target brightness to be determined may be brighter than the brightness of the display, which is determined according to the brightness of the ambient environment.

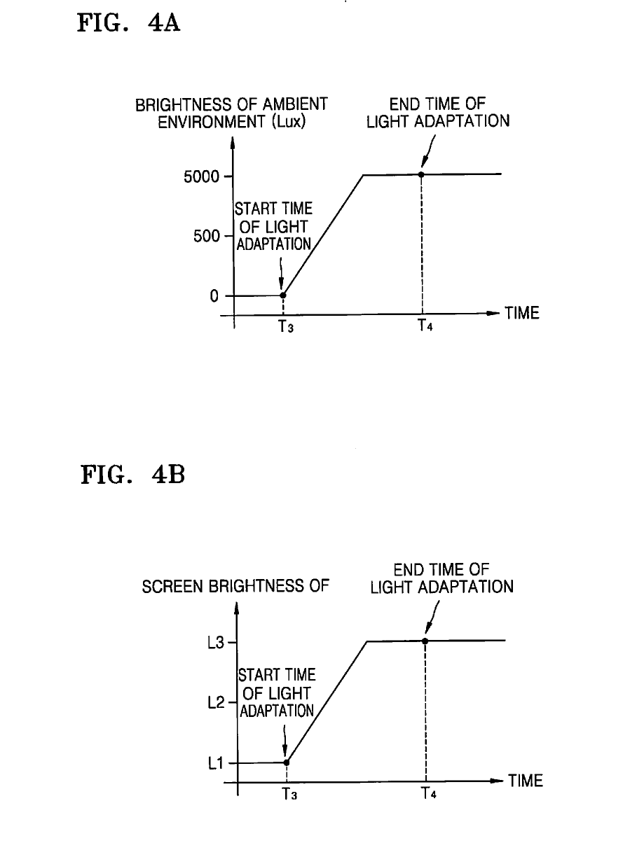

FIG. 4A is a graph illustrating a progress of light adaptation based on a brightness of an ambient environment, according to an exemplary embodiment.

Referring to FIG. 4A, in contrary to the embodiment of FIG. 3A, the brightness of the ambient environment may be changed from 0 Lux to 5000 Lux during a period of time from a time T₃ to a time T₄. Here, a temporal difference between the time T₃ and the time T₄ may be shorter than a time until the light adaptation is completed.

FIG. 4B is a graph illustrating a method of controlling a brightness of a display in a light adaptation state, according to an exemplary embodiment.

Referring to FIG. 4B, unlike the embodiment in which the brightness of the display in the dark adaptation state is controlled, the brightness of the display may be determined according to a brightness of an ambient environment without considering whether light adaptation progresses. As described above, to control the brightness of the display in consideration of the light adaptation does not significantly affect a user in watching the display, thus, the apparatus 100 may determine the brightness of the display without considering whether the light adaptation progresses.

Screen brightness L1 to L3 shown in FIG. 4B may correspond to the brightness 0 Lux to 5000 Lux of the ambient environment of FIG. 4A. In other words, in the case where the brightness of the display is controlled without considering whether the light adaptation progresses, when the brightness of the ambient environment is in a range between 0 Lux to 5000 Lux, the apparatus 100 may determine the brightness of the display to be the screen brightness L1 to L3, and may control the display according to the determined brightness.

On the other hand, unlike the embodiment shown in reference to FIG. 4B, when a progress of the light adaptation is considered, the apparatus 100 may determine the brightness of the display according to the progress of the light adaptation. Here, a target brightness of the display may be darker than the brightness of the display, which is determined based on the brightness of the ambient environment.

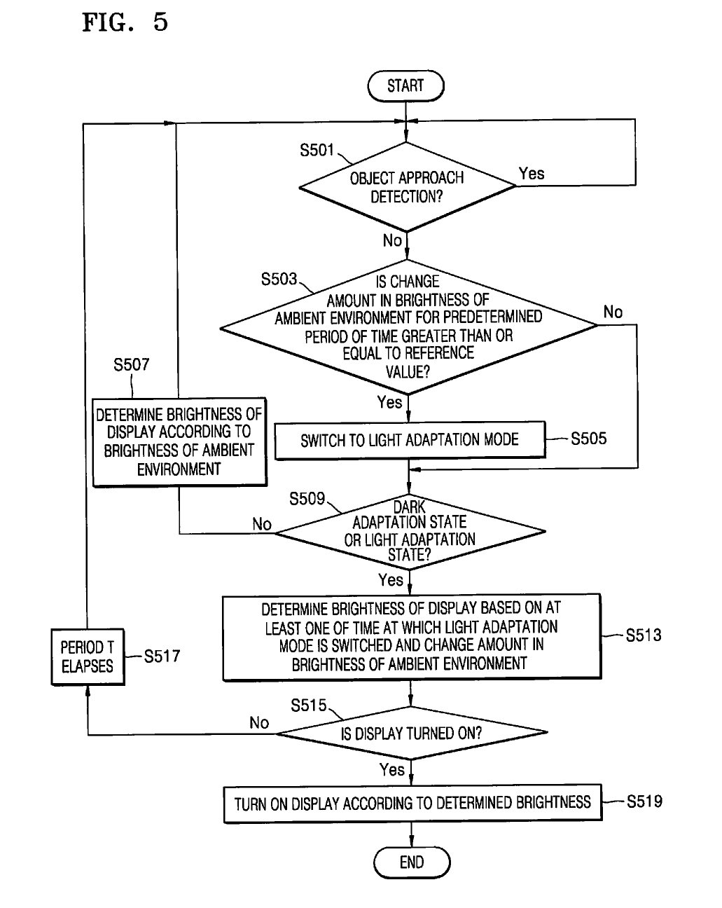

FIG. 5 is a flowchart showing a method of controlling a brightness of a display, according to an exemplary embodiment. Steps S503, S513, and S519 in the flowchart of FIG. 5 may correspond to steps S210, S203, and S205 of FIG. 2, respectively, and thus repeated descriptions will be omitted here.

Referring to FIG. 5, in step S501, the apparatus 100 may detect whether an object approaches the apparatus 100, by using a proximity sensor. For example, when a user puts the apparatus 100 into a pocket or when only a portion of the proximity sensor is blocked by the object, the aforementioned cases are not considered as a change in a brightness of an ambient environment. Therefore, when the apparatus 100 detects that the object approaches, by using the proximity sensor, in step 501, the apparatus 100 may not determine that a change amount in the brightness of the ambient environment is greater than or equal to a reference value, and thus may stand by.

When the apparatus 100 does not detect an approaching object, then in step S503, the apparatus 100 may determine whether the change amount in the brightness of the ambient environment which was measured by a brightness sensor is greater than or equal to the reference value.

That is, the apparatus 100 detects the change amount in the brightness of the ambient environment which was measured by the brightness sensor in order to determine whether the user is in a dark adaptation state or a light adaptation state.

When the change amount in the brightness of the ambient environment for the predetermined period of time is not greater than or equal to the reference value, then in step S509, the brightness of the display may be determined based on whether the dark adaptation or the light adaptation currently progresses.

When the change amount in the brightness of the ambient environment for the predetermined period of time is not greater than or equal to the reference value, then a mode is switched to a light adaptation mode in step S505 and then a period T passes in operation S517, the apparatus 100 determines whether the change amount in the brightness of the ambient environment for the predetermined period of time is greater than or equal to the reference value. Here, the period T may be a preset value. Therefore, even after the change in the brightness of the ambient environment is completed, the apparatus 100 may periodically determine whether the dark adaptation or the light adaptation progresses in operation S509, and may determine the brightness of the display in operation S513.

In operation S505, when the apparatus 100 does not detect the approaching object, by using the proximity sensor in operation S503, the apparatus 100 may determine that the change amount in the brightness of the ambient environment is greater than or equal to the reference value in operation S501, and therefore may switch the mode to the light adaptation mode. When the mode is switched to the light adaptation mode, the apparatus 100 may determine that the dark adaptation or the light adaptation progresses during a brightness adaptation time to be determined according to the change amount in the brightness of the ambient environment. In this case, the brightness adaptation time may be determined in proportion to the change amount in the brightness of the ambient environment.

As the mode is switched to the light adaptation mode in step S505, the apparatus 100 may determine in step S509 whether the user undergoes the dark adaptation or the light adaptation state. When the brightness of the ambient environment increases, the apparatus 100 may determine whether the light adaptation progresses. In addition, when the brightness of the ambient environment decreases, the apparatus 100 may determine whether the user undergoes the dark adaptation.

For example, when the mode is switched to the light adaptation mode in step S505 and then the light adaptation time does not elapse, the apparatus 100 may determine in step S509 whether the user is in the dark adaptation state or the light adaptation state. In this case, the light adaptation time may be set after the change in the brightness of the ambient environment is completed. In addition, because the dark adaptation or the light adaptation may progress as the brightness of the ambient environment is changed, the light adaptation time may be changed whenever the brightness of the ambient environment is changed.

In step S509, when the user undergoes the dark adaptation or the light adaptation due to the change in the brightness of the ambient environment, the apparatus 100 may determine the brightness of the display according to the dark adaptation state or the light adaptation state in step S513. That is, in step S513, the apparatus 100 determines the brightness of the display based on at least one of a time at which the apparatus is switched to the light adaptation mode and the change amount in the brightness of the ambient environment.

For example, when the change in the brightness of the ambient environment is changed, as shown in FIG. 3A, the apparatus 100 may determine that the dark adaptation progresses for approximately 45 minutes after the mode is switched to the light adaptation mode in step S505. Here, the light adaptation time may be determined as approximately 45 minutes at a time when the brightness of the ambient environment becomes 0 Lux.

In addition, when the change in brightness of the ambient environment is changed, as shown in FIG. 4A, the apparatus 100 may determine that the light adaptation progresses for approximately 1 minute after the mode is switched to the light adaptation mode in step S505. In this case, the light adaptation time may be determined as approximately 1 minute at a time when the brightness of the ambient environment becomes 5000 Lux.

Furthermore, as described above, when the brightness of the ambient environment increases, the apparatus 100 may not determine whether the light adaptation progresses, and may determine, in step S507, the brightness of the display according to the brightness of the ambient environment.

When the apparatus 100 determines in step S509 that the dark adaptation or the light adaptation has completed, i.e., the light adaptation time has elapsed, and therefore the dark adaptation or the light adaptation does not currently progress, the apparatus 100 may determine the brightness of the display according to the brightness of the ambient environment in step 5507. Here, the time at which the apparatus 100 determines that the dark adaptation or the light adaptation does not currently progress may be a time after the time T₂ or the time T₄, as shown in FIG. 3B or FIG. 4B, which is the time that is used to determine that the light adaptation time has elapsed.

In step S515, when the display is turned off, the apparatus 100 may perform steps S501 to S513 for a period T, in step S517. The period T is a preset value. Therefore, even after the change in the brightness of the ambient environment is completed, in step S503, the apparatus 100 periodically determines whether the dark adaptation or the light adaptation progresses in operation S509, and determines the brightness of the display in step S513.

When the display is turned on, in step S515, the apparatus 100 may control the display to be turned on according to the brightness of the display determined in step S513. In this case, the display 130 may be turned on by a user's input signal, a display operation signal generated by the apparatus 100, or a display operation signal received from an external source.

In step S519, when the display is turned on according to the brightness determined in step S513, the display may maintain its brightness determined in step S513 until the display is turned off As described above, in general, since the user watches the display when the display is turned on, the user's eyes may be adapted to the brightness of the display rather than the brightness of the ambient environment. In other words, the user's eyes may not undergo the dark adaptation or the light adaptation according to a change in an ambient environment but may be adapted to the brightness of the display. Therefore, the apparatus 100 may not again determine the brightness of the display according to the dark adaptation state or the light adaptation state based on the brightness of the environment or the change in the brightness of the ambient environment until the display is turned off.

When the display is turned off, the apparatus 100 may repeatedly perform an operation of determining the brightness of the display in step S513, based on whether the user is currently in the dark adaptation state or the light adaptation state as the apparatus determines in step S503 that the change amount in brightness of the ambient environment is greater than or equal to the reference value. Whether the user is currently in the dark adaptation state or the light adaptation state may be estimated based on whether the light adaptation time has elapsed.

On the other hand, when the brightness of the display is determined and then the display is not turned on in step S515, and the time has elapsed by the period T in step S517, the apparatus 100 may again determine in step S503 whether the change amount in the brightness of the ambient environment is greater than or equal to the reference value. In other words, the apparatus 100 may periodically determine the brightness of the display because the brightness of the ambient environment is changed while the display is turned off. Therefore, the apparatus 100 may periodically determine the brightness of the display according to the change amount in the brightness of the ambient environment.

Furthermore, after step S503, the apparatus 100 may continuously and periodically detect the change amount in the brightness of the ambient environment for the predetermined period of time while steps S505 to S513 are performed and therefore may determine whether the detected changed amount in brightness is greater than or equal to the reference value. In other words, when the apparatus 100 determines that the change amount in the brightness of the ambient environment for the predetermined period of time is greater than or equal to the reference value while steps S505 to S513 are performed, the apparatus 100 may re-determine the brightness of the display according to the change amount in the brightness through steps S501 to S509.

As described above, according to the one or more of the above exemplary embodiments, even when the brightness of the ambient environment is changed, the brightness of the display is controlled according to the user's brightness adaptation state, so that the user may optimally recognize the display.

As described above, according to the one or more of the above exemplary embodiments, when an approaching object is detected by the proximity sensor, the apparatus determines that the brightness of the ambient environment is not changed, so that, although the brightness detected by the brightness sensor is changed, the brightness of the display may not be changed.

In addition, other exemplary embodiments may also be implemented through computer readable code/instructions in/on a medium, e.g., a computer readable medium, to control at least one processing element to implement any of the above described embodiments. The medium may correspond to any medium/media permitting the storage and/or transmission of the computer readable code. The computer readable code may be recorded/transferred on a medium in a variety of ways, with examples of the medium including recording media, such as magnetic storage media (e.g., ROM, floppy disks, hard disks, etc.) and optical recording media (e.g., CD-ROMs, or DVDs), and transmission media such as Internet transmission media.

It should be understood that the embodiments described therein should be considered in a descriptive sense only and not for purposes of limitation. Descriptions of features or aspects within each embodiment should typically be considered as available for other similar features or aspects in other embodiments.

While one or more exemplary embodiments have been described with reference to the figures, it will be understood by those of ordinary skill in the art that various changes in form and details may be made therein without departing from the spirit and scope of the exemplary embodiments as defined by the following claims.

What is claimed is:

1. A method of controlling a display, the method comprising:
detecting whether a change amount in brightness of an ambient environment of an apparatus, for a predetermined period of time, is greater than or equal to a reference value;
determining brightness of the display, based on a result of the detecting; and
when an operation signal of the display is detected, turning on the display according to the brightness determined at a time when the operation signal is detected.

2. The method of claim 1, wherein determining the brightness of the display comprises:
switching a mode of the apparatus to a light adaptation mode based on the result of the detecting; and
when the mode is switched to the light adaptation mode, determining the brightness of the display, based on at least one of a time when the mode is switched to the light adaptation mode and the change amount in the brightness of the ambient environment.

3. The method of claim 1, wherein detecting the charge amount comprises:
standing by, when an approach of an object to the apparatus is detected, until the object is no longer detected; and
when the object is no longer detected, detecting whether the change amount in the brightness of the ambient environment for the predetermined period of time is greater than or equal to the reference value.

4. The method of claim 2, wherein, when the mode is not switched to the light adaptation mode, determining the brightness of the display comprises determining the brightness of the display, based on a level of the brightness of the ambient environment.

5. The method of claim 1, wherein turning on the display comprises maintaining the brightness of the display at the time when the display was turned on until the display is turned off.

6. The method of claim 1, wherein the reference value is determined based on an amount of brightness to which a user's eyes are adapted when dark adaptation or light adaptation progresses for the predetermined period of time.

7. An apparatus comprising:
a sensor unit configured to detect whether a change amount in brightness of an ambient environment of an apparatus, for a predetermined period of time, is greater than or equal to a reference value;
a control unit configured to determine brightness of the display, based on a result of the detecting, and when an operation signal of the display is detected, controlling the display to be turned on according to the brightness determined at a time when the operation signal is detected; and
a display operating according to the operation signal and the determined brightness.

8. The apparatus of claim 7, wherein the control unit switches a mode of the apparatus to a light adaptation mode based on the result of the detecting, and when the mode is switched to the light adaptation mode, determines the brightness of the display, based on at least one of a time when the mode is switched to the light adaptation mode and the change amount in the brightness of the ambient environment.

9. The apparatus of claim 8, wherein after the sensor unit detects an approach of an object to the apparatus, when the object is no longer detected, the sensor unit detects whether the change amount in the brightness of the ambient environment for the predetermined period of time is greater than or equal to the reference value.

10. The apparatus of claim 8, wherein when the mode of the apparatus is not switched to the light adaptation mode, the control unit determines the brightness of the display, based on a level of the brightness of the ambient environment.

11. The apparatus of claim 7, wherein the control unit controls the display to maintain the brightness of the display at the time when the display was turned on until the display is turned off.

12. A non-transitory computer-readable recording medium having recorded thereon a program which, when executed by a computer, performs the steps of:
detecting whether a change amount in brightness of an ambient environment of an apparatus, for a predetermined period of time, is greater than or equal to a reference value;
determining brightness of the display, based on a result of the detecting; and
when an operation signal of the display is detected, turning on the display according to the brightness determined at a time when the operation signal is detected.
